(19) United States
(12) Patent Application Publication
(10) Pub. No.: US 2011/0173280 A1
(43) Pub. Date: Jul. 14, 2011

(54) STATUS MESSAGES CONVEYED DURING COMMUNICATION SESSION TO SESSION PARTICIPANTS

(75) Inventors: NOBUYUKI ISHIKAWA, YAMATO-SHI (JP); KAZUHIRO KONNO, YAMATO-SHI (JP); AKIRA SAITO, YAMATO-SHI (JP); SHIGEKI TAKEUCHI, YAMATO-SHI (JP); HAYATO UENOHARA, YAMATO-SHI (JP)

(73) Assignee: INTERNATIONAL BUSINESS MACHINES CORPORATION, ARMONK, NY (US)

(21) Appl. No.: 13/069,544

(22) Filed: Mar. 23, 2011

(30) Foreign Application Priority Data
Oct. 7, 2008 (JP) 2008-260325

(51) Int. Cl. G06F 15/16

(52) U.S. Cl. 709/206

(57) ABSTRACT

At least two applications can be instantiated on a client device. Each of the at least two applications can include a user interface for interacting with a user of the client device. One of the applications can be a real-time communication application through which the user is participating in a real-time communication session with at least one remotely located user. Another of the applications can be referred to as a second application. Status information relating to user interactions with the second application can be determined. A status message can be generated that includes content from the determined status information. The status message can be generated without manually entered user input. The status message can be conveyed automatically and without manual user input to the at least one remotely located user via the real-time communication application during the real-time communication application.

### FOREIGN PRIORITY

This application claims priority to the Japanese Application No. 2008-260325, filed Oct. 7, 2008.

### BACKGROUND

The disclosure relates to real-time text exchange communications and communication sessions.

In recent years, real-time communications where text is exchanged between two or more participants has become increasingly popular. For example, chat communications (such as instant messaging) are often used.

Real-time message exchanges are to be contrasted with non-real-time mechanisms, such as electronic mails and electronic bulletin boards. In these non-real-time communications, a message can be sent unilaterally. This type of unilateral communication is possible whether the other party of communication is available or not at the time the message was sent. It may take a long time until the user receives the reply.

In contrast, during real-time message exchanges a communication session is established between two or more people, which are concurrently participating in the communication session. This type of communication is bi-directional and feedback/message can be instantly read and responded to during the communication session. Because communication occurs concurrently, a technique of displaying presence information showing the status of the other party is used. This status informs a potential communicator whether a desired individual is available for a communication session.

### BRIEF SUMMARY

One aspect of the disclosure is for a method, computer program product, system, and/or apparatus for providing a user status during a real-time communication session to other users of the communication session. In the aspect, at least two applications can be instantiated on a client device. Each of the at least two applications can include a user interface for interacting with a user of the client device. One of the applications can be a real-time communication application through which the user is participating in a real-time communication session with at least one remotely located user. Another of the applications can be referred to as a second application. Status information relating to user interactions with the second application can be determined. A status message can be generated that includes content from the determined status information. The status message can be generated without manually entered user input. The status message can be conveyed automatically and without manual user input to the at least one remotely located user via the real-time communication application during the real-time communication application.

One aspect of the disclosure is for a method, computer program product, system, and/or apparatus for providing a user status during an Instant Messaging (IM) communication session to other users of the communication session. An instant messaging (IM) status agent can execute on a client device, which also executes an IM application having a user interface through which a human user corresponds to at least one remotely located user during an IM communication session. At least one active window can be determined for an application that is not the IM application, wherein the application is referred to as a second application. Without manual user input from the human user a status message can be generated. The status message can indicate that the human user is interacting via the second application. The status message can be conveyed via the IM application to the at least one remotely located user.

### BRIEF DESCRIPTION OF THE SEVERAL VIEWS OF THE DRAWINGS

FIG. 1 shows an overall configuration of a computer system according to an embodiment of the disclosure;

FIG. 2 shows a functional configuration of a client according to an embodiment of the disclosure;

FIG. 3 shows a rule definition for use in an embodiment of the disclosure;

FIG. 4 is a flowchart illustrating an operation of a message processing unit in the client of an embodiment of the disclosure;

FIG. 5 is a flowchart illustrating an operation of a window monitoring unit in the client of an embodiment of the disclosure;

FIG. 6 is a flowchart illustrating an operation of a rule interpreting unit in the client of an embodiment of the disclosure;

FIGS. 7A, 7B, and 7C show examples of the information obtained or generated by the rule interpreting unit in the client of an embodiment of the disclosure;

FIG. 8 is a flowchart illustrating a detailed operation for status matching processing which is performed by the rule interpreting unit in the client of an embodiment of the disclosure; and

FIG. 9 shows a hardware structure of a computer to which the embodiment of the disclosure is applicable.

### DETAILED DESCRIPTION

Displaying presence information during a real-time text exchange communication commonly occurs by using a contact list, a BUDDY LIST, and similar artifacts. This information is useful to know whether a communication session (e.g., an IM session) can be initiated successfully. This information is less helpful, however, during the communication session.

No existing “presence information” related to a communication session helps to inform participants of activities of other participants during the session. That is, often one or more session participant is unaware of whether actions are being taken during the communication session by another, or whether another session participant is not actively engaged in activities related to the communication session. One of the few “status” messages currently possible during a real-time text exchange communication session is an indicator that a person is typing within the text input session of an instant messaging interface. This lets participants know that they can expect to receive a message shortly. This is especially useful when relatively long messages are being entered, which causes other session participants to wonder what is going on in absence of receiving a message that the other participant is typing.

During the course of developing inventive content of the current disclosure, Applicants have discovered that additional situations (ones other than a user typing a response) exist, which result in delays during a communication session. Specifically, many modern forms of real-time communication involve an exchange of additional content (e.g., files, video, etc.) that supplement the communication exchange. These file may have to be opened in applications other than the IM application, and delays (in responses to IM communication) can be expected as this information is digested.

At present, it is impossible to know whether the other party of a communication session is doing any work related to the message exchange, doing nothing, or is doing something completely unrelated to the communication session. That is, the only way to know what a user is going, is to rely on user-input messages (such as “give me a minute, I′m looking at the video now). These messages are often not communicated, as the user who could send such a message is currently busy with other activity (such as looking at a video, editing a document, etc.). Even if a user does think to send a message, the time required to do so could otherwise be spent performing the activity in question (which would help expedite the real-time communication session).

Resolving this uncertainty by providing additional feedback during a communication session on a participants status, is believed to greatly enhance the end-user experience during a communication session, which is why a solution to this effect has been developed and expressed herein.

The present disclosure provides an ability to communicate desktop status information from one participant in a communication session (e.g., an instant messaging session) to another. This desktop status information can, for example, include what applications a user is running on their desktop in addition to the IM application, and what activities are being performed with these applications during the IM session. In one embodiment, the desktop status information that is communicated can be restricted to information related and pertinent to the instant messaging session.

For example, a user can be completing a report, uploading/downloading a file, etc., which is consistent (or inconsistent) with communication elements discussed during the IM session. The desktop status information and related messages can be conveyed without active user intervention, in one embodiment.

Thus, if a user is receiving and opening a PFD document conveyed during the IM session and discussed during the IM session, a notification can be sent (via IM message and the IM interface) informing a communication participant that another participant is waiting for the document to arrive, is opening the document, is reading the document, etc. Additionally, in one embodiment, a series of rules can be defined to determine what information is communicated to others and what is not during a communication session. This exchanged information can have a nexus with desktop activities outside the instantiated IM application, which is utilized to participate in the IM session and/or to convey the desktop status information.

The disclosure is now described within the context of one or more embodiments, although the description is intended to be illustrative of embodiments of the invention as a whole, and is not to be construed as limiting other embodiments of the invention to the embodiments shown. It is appreciated that various modifications may occur to those skilled in the art that, while not specifically shown herein, are nevertheless within the true spirit and scope of the invention.

As will be appreciated by one skilled in the art, aspects of the disclosure may be embodied as a system, method or computer program product. Accordingly, aspects of the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

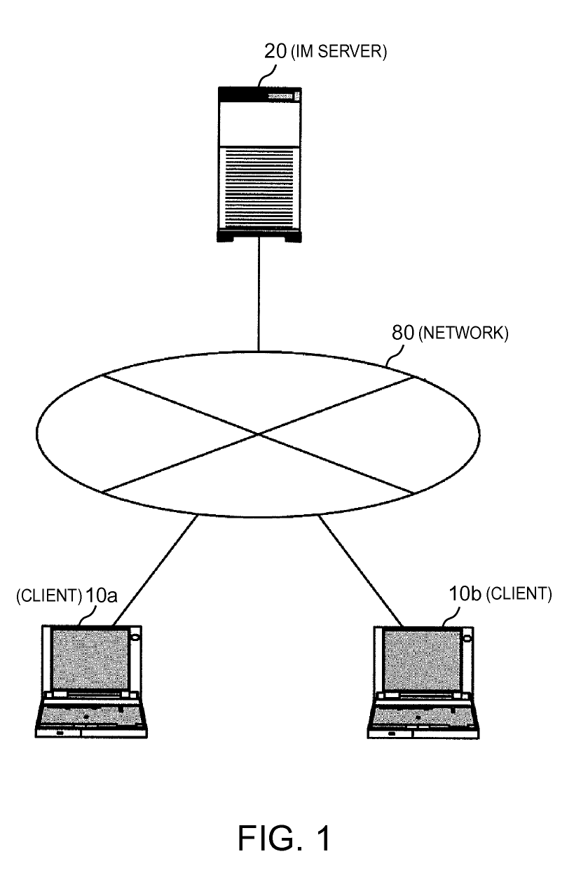

Reference is now made to FIG. 1, which shows by way of example an overall configuration of the computer system. FIG. 1 shows a computer system that includes a client 10a, a client 10b, and an Instant Messaging (IM) server 20, which are connected to each other via a network 80.

The clients 10a and 10b are terminal devices such as personal computers (PCs), mobile phones, kiosks, etc. More specifically, the clients (10a and 10b) are each a terminal device used by a human user to exchange messages with one or more other users. In one embodiment, one or more automated software agents can be a communication endpoint involved in a session where messages are conveyed (as opposed to a session having human user-to-user communications). The communication session where messages are conveyed can be a real-time communication within which text exchanges are possible. For example, instant messaging communications, chat forum communications, text messages, co-browsing, real-time collaboration, and the like can be considered communication sessions for purposes of the disclosure. Additionally, modality conversions (e.g., from text to speech and/or speech to text) can occur so that one or more of the participants of a communication session are interacting with a client 10a, 10b using voice input/output. Although two clients are shown in the figure, any number (1 to N) of clients can be utilized and are contemplated. In the following, the client 10a, 10b may simply be referred to as the “client 10” when the distinction is unnecessary.

The IM server 20 is a server computer which manages message exchange by IM via the network 80. For example, in response to requests for participation in the same IM session from the client 10a operated by a user A and the client 10b operated by a user B, the IM server 20 manages identification information of the IM session, identification information of the users A and B, and identification information of the clients 10a and 10b. Further, in response to input of a message from the user A or B, the IM server 20 controls such that the message is transmitted to the client 10 of the other party.

Use of the term IM server 20 is to be understood to represent a server that facilitates real-time communications that can include an exchange of text. Thus, a chat server, a GOOGLE WAVE server, a collaboration server, an online meeting server, and other related categories of servers are to be included in the definition of IM server 20 as used herein. Further, a combination of servers (that together maintain presence information and facilitate a real-time exchange of text messages over a network 80 are contemplated). For example, a peer-to-peer network, where an aggregation of the peers performs the functions of IM server 20, can be considered an IM server 20 as detailed herein.

The network 80 is communication means used for message exchange. The network 80 may be the Internet, a LAN (Local Area Network), a metropolitan area network (MAN), etc. That is, Network 120 can include any hardware/software/and firmware necessary to convey data encoded within carrier waves. Data can be contained within analog or digital signals and conveyed though data or voice channels. Network 80 can include local components and data pathways necessary for communications to be exchanged among computing device components and between integrated device components and peripheral devices. Network 80 can also include network equipment, such as routers, data lines, hubs, and intermediary servers which together form a data network, such as the Internet. Network 80 can also include circuit-based communication components and mobile communication components, such as telephony switches, modems, cellular communication towers, and the like. Network 80 can include line based and/or wireless communication pathways.

In the computer system having the above-described configuration, in the present embodiment, an IM status agent is installed in each client 10. The IM status agent determines a status of a user (or, a user status) from information regarding the user's activity related to the IM (hereinafter, referred to as the “user activity information”), and displays the determined user status on the client 10 of the other party, to ensure smoother communication between the users. The “user activity information” can include “desktop status information” which relates to activities that a user is performing via a desktop interface. These activities can occur outside the boundaries of the instantiated IM application, yet can related and/or be pertinent to the communication session. For example, activities can include what window has focus, what documents are open within other windows of the desktop, a status of file exchanges, email message arrivals, what content/documents is presently displayed on a user's desktop, and the like.

For example, the user activity information includes: IM status information; activated application information (activated AP information); window status information; and events occurring within activated applications (other than the IM application used to participate in the communication session).

Among them, the IM status information indicates a status of a message in the IM. For example, it indicates an input status of a message text to the IM (i.e., whether the message text is being input). The IM status information can also indicate whether the IM window has focus within a desktop or whether another application window currently has focus.

The activated AP information shows an application which is activated by a user operation on the IM. This information includes, for example, a name of the activated application, and a process ID which uniquely identifies the process generated as a result of activation of the application.

The window status information indicates a status of a window for the application activated by the user operation on the IM. Specifically, it shows, for example, a focus status of the window (i.e., whether a user operation is being performed on the window), and a status of switch of focus between windows (i.e., whether the user operations are being performed on the window and another window).

The user status to be displayed on the client 10 of the other party is transmitted in the form of a status message. The status message can be dynamically conveyed by a system without explicit manual input from a user. That is, the client 10a, 10b can determine content of the status message and can determine whether or not the status message is to be sent to others participating in the communication session. In one embodiment, the status message can be sent to a relevant sub-set of users, which is less than the set of users participating in the communication session. IM status messages can be customized by configuration options (user configurable) established by the user (for whom the status information is generated) and/or can be customized for the receiver of the IM status messages in accordance with configuration options established by the receiver of the IM status messages.

As will be described later, the status message can be generated in accordance with a rule in association with the definitions regarding the IM status information and the window status information. In the present embodiment, the status message is used as an example of the user status information indicating the status of the user. As used herein, the “status of the user” refers to the status related to the user operation on the software activated in the client 10, wherein the software may be either or both of the IM (e.g., the application that a user is utilizing to participate in the communication session with others) and an application activated from the IM (e.g., an application distinct from the instantiated IM application that is running on the client 10a, 10b concurrent with the IM application instance).

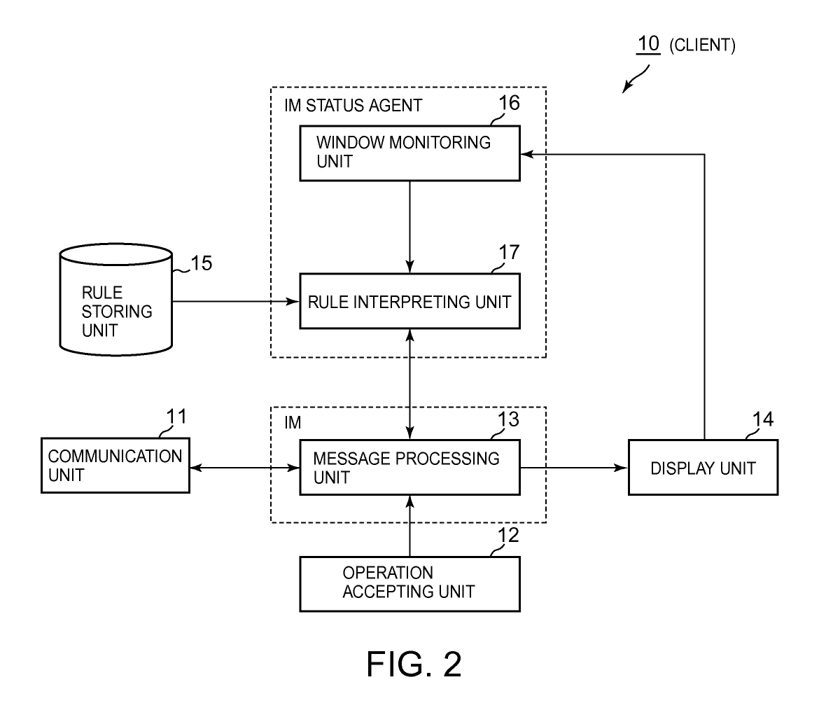

One embodiment showing a functional configuration of the client 10 will be described, as indicated by FIG. 2. That is, FIG. 2 is a block diagram showing an example of the functional configuration of the client 10.

As shown in the figure, the client 10 includes a communication unit 11, an operation accepting unit 12, a message processing unit 13, a display unit 14, a rule storing unit 15, a window monitoring unit 16, a rule interpreting unit 17, and/or other such components.

The communication unit 11 transmits and receives messages to and from the client 10 of the other party of communication. In the present embodiment, the communication unit 11 is shown as an example of the notification unit which notifies the user status information.

The operation accepting unit 12 accepts a user operation, such as a keyboard operation, mouse operation, and the like, on the client 10.

The message processing unit 13, which is a function implemented as the CPU in the client 10 executes the IM program, performs processing related to messages, such as message exchange with another client 10.

Upon activation of the message processing unit 13, the display unit 14 displays a window for the IM, a message, and others, whereas upon activation of another application from the message processing unit 13, the display unit 14 displays a window for that application.

The rule storing unit 15 stores, for each application which may be activated from the IM, a rule definition in which a definition of a condition regarding the status of the message in the IM (hereinafter, referred to as the “IM status definition”) and a definition of a condition regarding the status of the window for the application (hereinafter, referred to as the “window status definition”) are associated with each other. In the present embodiment, the IM is shown as an example of the first software that is operated by the user for the message exchange, and the application which may be activated from the IM is shown as an example of the second software that is different from the first software. Further, the rule storing unit 15 is shown as an example of the storing unit which stores association information in which the user status information is associated with the second software.

The window monitoring unit 16 and the rule interpreting unit 17 are the functions which are implemented within computer program instructions that are stored in a storage medium, such as a memory of the client 10. The computer program instructions (that may be part of an IM status agent grogram) can be executed by the CPU in the client 10. Units 16 and/or 17 check the IM status information and the window status information at regular intervals, and if the checked result matches a rule included in the rule definitions stored in the rule storing unit 15, units 16 and/or 17 output the status message defined in that rule to the message processing unit 13.

Specifically, the window monitoring unit 16 monitors the windows displayed on the display unit 14 to check the windows the user is working on. A z-stack order maintained by an operating system of the client 10 can be queried by monitoring unit 16, for example, in one contemplated embodiment. This z-stack order can be used to determine not only which windows are currently active in a desktop, but also indicate which window current has focus.

The rule interpreting unit 17 reads the rule definitions from the rule storing unit 15, and determines whether the IM status information and the window status information match the IM status definition and the window status definition, respectively. If they both match, the rule interpreting unit 17 retrieves and passes the status message associated with the IM status definition and the window status definition to the message processing unit 13. In the present embodiment, the rule interpreting unit 17 is shown as an example of the reading unit which reads into a memory the association information in which the user status information is associated with the second software and also as an example of the output unit which outputs the user status information to the first software.

Although the IM status agent is shown separately from the IM in the figure, the IM status agent may be included in the IM software as plug-in software and the like.

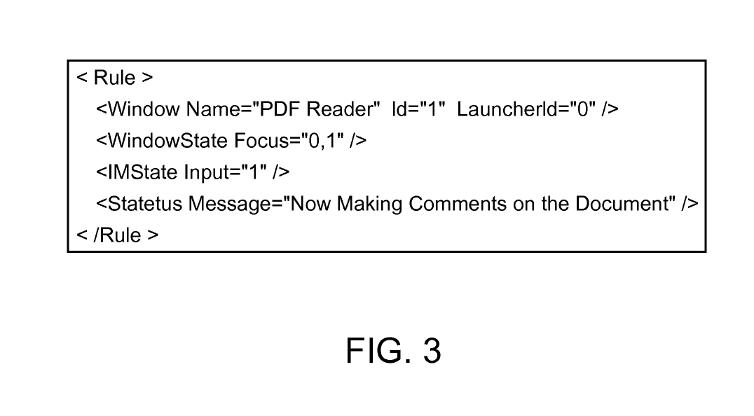

FIG. 3 shows a specific example of the rule definition stored in the rule storing unit 15 in accordance with an embodiment of the disclosure. In FIG. 3, the example of the rule definition is described in a markup language format (for example, XML) for convenience of explanation.

The example of the rule definition in the present embodiment is a collection of action rule definitions for the IM status agent (hereinafter, simply referred to as the “action rule definitions”). <Rule> to </Rule> constitute a unit of the action rule definitions, which coincides with a unit of processing executed by the rule interpreting unit 17. The action rule definitions include the following definitions, which are included in the rule definition for the purposes of associating the user activity information with the status messages.

Action rule definitions include a window definition, which is defined as a Window element. The window definition defines information which specifies the window (hereinafter, referred to as the “object window”) on which a user activity indicated by the user activity information that is associated with a status message is performed.

The Window element may define the following attributes, with “*” indicating a mandatory attribute:
Name*: a character string showing the application name (regular expression may also be used).

Id*: a window ID for identification of the object window, used in the window status definition and others. Here, the Id takes the numerical value other than “0”, because the window ID “0” is applied to the IM window.

LauncherId: a window ID of the window for the application (launcher) that activated another application. In the absence of this definition, the launcher is regarded as arbitrary.

In the figure, the window for “PDF Reader”, which is the application activated from the IM (with the window ID “0”), has a window ID defined as “1”.

Another description as follows is possible, wherein the window for “Web Browser”, which is another application activated from the application that is opening the window with the window ID “1”, has a window ID defined as “2”:
<Window Name=“Web Browser” Id=“2” LauncherId=“1”/>.

Action rule definitions include a window status definition, which is defined as a WindowState element. The window status definition defines a condition regarding the status of the object window.

The WindowState element may define the following attributes, with definition of either Focus or Visible being mandatory:
Focus: a list of window IDs for the windows among which focus is switched. A negation symbol may be added to the list to define a condition that all of the windows having the window IDs in the list are not focused. Alternatively, the negation symbol may be added to any of the window IDs in the list to define a condition that the window having the corresponding window ID is not focused.
Visible: a list of window IDs for the windows which remain open, instead of being minimized to icons and the like. The negation symbol may be added to the list to define a condition that all of the windows having the window IDs in the list are minimized to icons. Alternatively, the negation symbol may be added to any of the window IDs in the list to define a condition that the window having the corresponding window ID is minimized to an icon.

Here, the list includes the window IDs separated by commas. If there is “0” in the list, it represents the window for the IM. For the negation symbol, any symbol, “!” for example, may be used.

Defined in the figure is the status in which focus is switched between the window for the IM (with the window ID “0”) and the window for the PDF viewing software “PDF Reader” (with the window ID “1”).

Another description as follows is possible, which defines the status in which the IM window (with the window ID “0”) and the window with the window ID “2” are open, without being minimized to icons, and focus is switched between the windows with the window IDs “1” and “4”:
<WindowState Visible=“0,2” Focus=” 1,4″/>

Action rule definitions include an IM status definition, which is defined as an IMState element. The IM status definition defines the condition related to the status of the IM application.

The IMState element may define the following attributes:
Input: a numerical value indicating whether a message is being input to the IM. For example, it takes either “0” (not being input) or “1” (being input).

Presence: a numerical value indicating the presence status of the IM. Typical presence statuses may be defined, e.g., as: 0—Active (possible to answer), 1—Away (away from keyboard), 2—Idle (no operation), 3—Inactive (impossible to answer), and others, although the numerical values may vary depending on the types of the IM.

Shown in the figure is the status in which the message is being input to the IM.

Another description as follows is possible, which defines that the presence status of the IM is Idle and the message is being input:
<IMState Presence=“2” Input=“1”/>

Action rule definitions include an IM status modification definition, which is defined as a Status element. The IM status modification definition defines an IM status to which the status is to be modified in the case where the actual status satisfies the condition defined in the rule definition. In the present embodiment, particularly, it includes the definition of a status modification instruction (to update a status message and the like), which is notified to the IM when the status matches the rule.

The Status element may define the following attributes:
Message: a character string which instructs modification of the status message of the IM. It defines the status message itself.
Presence: a numerical value which instructs modification of the presence status of the IM. Typical presence statuses may be defined, e.g., as: 0—Active (possible to answer), 1—Away (away from keyboard), 2—Idle (no operation), 3—Inactive (impossible to answer), and others, although the numerical values may vary depending on the types of the IM. In the absence of this definition, the presence status is not changed.

In the figure, it is defined such that the IM status message is changed to “Now Making Comments on the Document” when the status matches the condition defined in the rule definition.

The example of the rule definition shown in FIG. 3 is applicable, for example, to the following scenario:
(1) A PDF file is transmitted by the file transmitting function of the IM.
(2) The user performs an operation to open the PDF file on the IM, for example, to activate the PDF viewing software “PDF Reader”. At this time, the IM passes the process ID for the activated PDF viewing software to the IM status agent.
(3) The IM status agent monitors the foreground window, i.e., the window on which the user is working, at regular intervals.
(4) As a result, the foreground window is the window for the PDF viewing software (with window ID “1”) or the window for the IM (with window ID “0”). Here, whether the window for the PDF viewing software has been activated from the IM is confirmed with the process ID passed from the IM in (2) above. The above-described status of the windows satisfies the condition described in the WindowState element in the rule definition.
(5) Further, the text is input into the input window for the IM. This status satisfies the condition described in the IMState element in the rule definition.
(6) The IM status agent notifies the IM of an instruction to change the status message to: “Now Making Comments on the Document”, according to the Status element in the rule definition.

An operation of the present embodiment will now be described. While the rule definition in FIG. 3 allows setting of values other than “0” as the LauncherId attribute in the Window element, it is assumed in the following that only “0” can be set therefor, for ease of explanation. Further, while the rule definition in FIG. 3 allows definition of both the Focus attribute and the Visible attribute in the WindowState element, it is assumed in the following that only the Focus attribute can be defined therefor, again for ease of explanation.

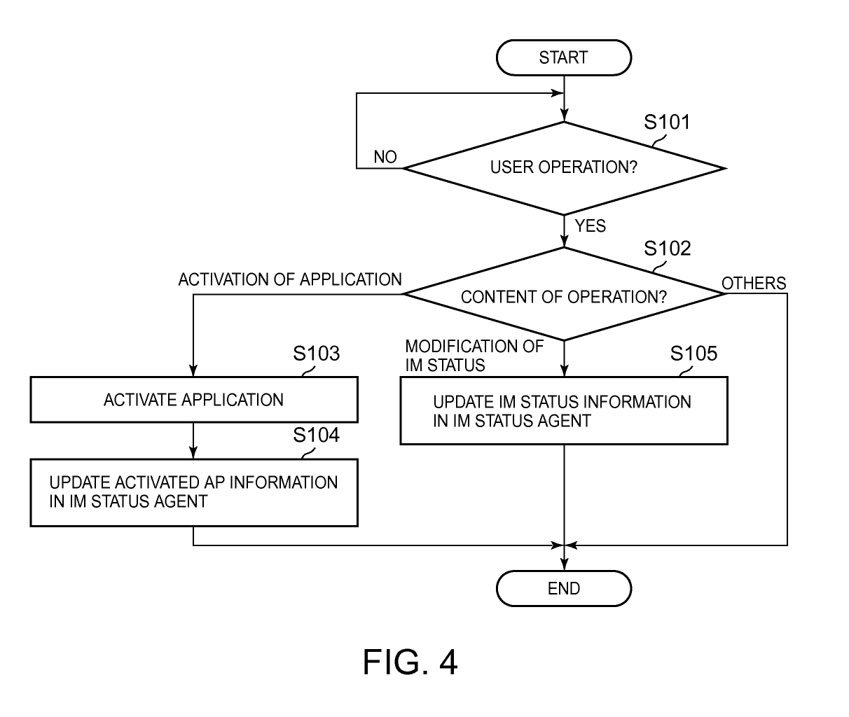

FIG. 4 is a flowchart illustrating an example of the operation of the message processing unit 13 in the present embodiment.

Firstly, the message processing unit 13 determines whether a notification that there was a user operation has been received from the operation accepting unit 12 (step 101). It repeats step 101 until such a notification is received, and once it receives the notification, it determines the content of the user operation (step 102).

Assume it is determined that the user operation is the one for activating an application.

In this case, the message processing unit 13 activates the designated application (step 103). It then notifies the rule interpreting unit 17 of activated AP information related to the activated application, for example by storing the information in a memory which is used for storing the activated AP information and which is accessible by the rule interpreting unit 17 (step 104). Here, it is assumed that the message processing unit 13 is able to recognize the type of the activated application, and the application name is included in the activated AP information. Further, the process ID for identification of a process generated as a result of activation of the application is also included in the activated AP information.

Assume it is determined that the user operation is the one for modifying the status of the IM.

In this case, the message processing unit 13 notifies the rule interpreting unit 17 of the IM status information, for example by storing the information in a memory used for storing the IM status information, which can be accessed by the rule interpreting unit 17 (step 105). Here, the IM status information may be the one indicating that a text is being input to the IM.

In the case where it is determined that the content of the user operation is other than described above, processing is performed in accordance with that user operation before termination of the process. The processing based on the user operation is irrelevant to the disclosure, and thus, description thereof will not be provided here.

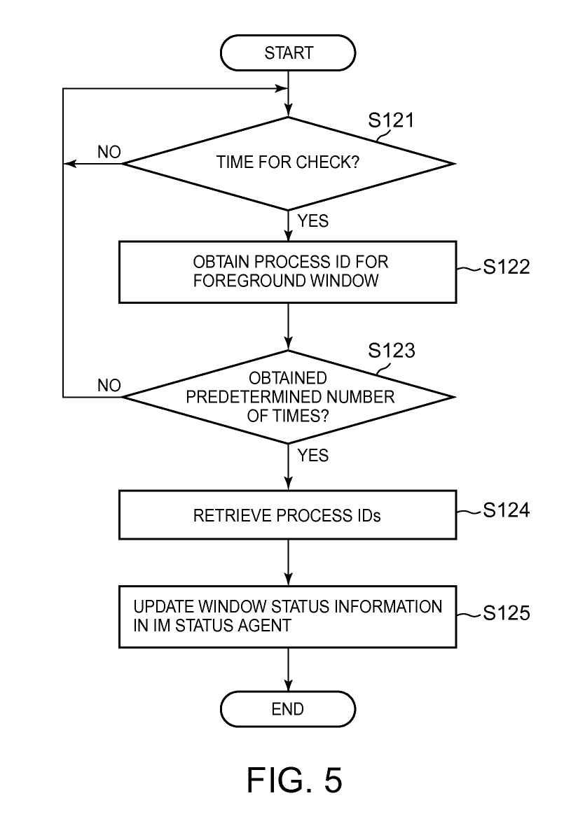

FIG. 5 is a flowchart illustrating an example of the operation of the window monitoring unit 16 in the present embodiment.

Window monitoring unit 16 determines whether it is time to check the windows (step 121). If it is not the time, it repeats step 121 until the time comes. If it is the time to check the windows, the window monitoring unit 16 obtains and stores in a memory the process ID of the application that opened the foreground window among the windows displayed on display unit 14 (step 122). To specify the foreground window among the windows displayed on the display unit 14, an API function of GetForegroundWindow, for example, may be used. Thereafter, the window monitoring unit 16 determines whether the process ID for the foreground window has been obtained a predetermined number of times (step 123).

As a result, if the process ID for the foreground window has not been obtained the predetermined number of times yet, steps 121 to 123 are repeated.

If the process ID for the foreground window has been obtained the predetermined number of times, the process IDs obtained in step 122 up to that point are retrieved from the memory (step 124). It then notifies the rule interpreting unit 17 of the obtained process IDs, by storing them in a memory which is used for storing the window status information and accessible by the rule interpreting unit 17 (step 125).

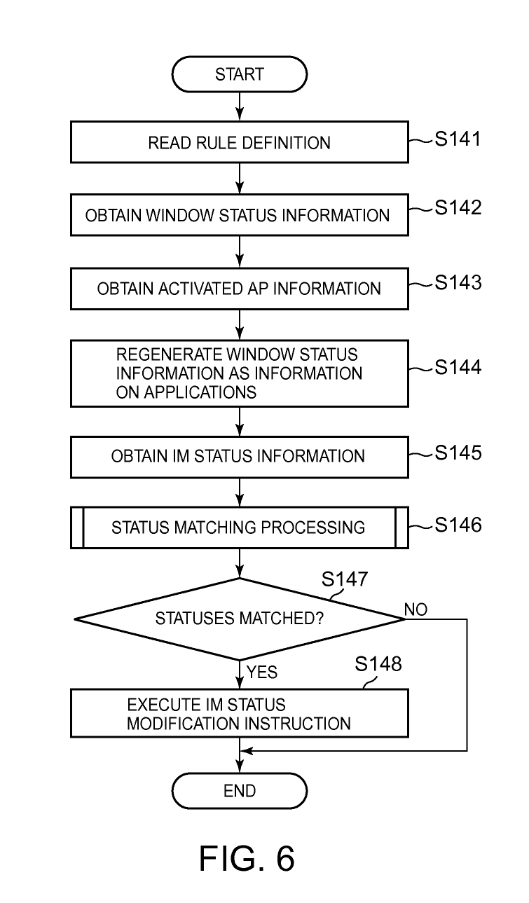

FIG. 6 is a flowchart illustrating an example of the operation of the rule interpreting unit 17 in the present embodiment. It is noted that prior to this operation, the message processing unit 13 has stored the activated AP information and the IM status information, and the window monitoring unit 16 has stored the window status information, in the corresponding memories accessible by the rule interpreting unit 17.

Rule interpreting unit 17 reads the rule definition from the rule storing unit 15 (step 141).

Rule interpreting unit 17 obtains the window status information that the window monitoring unit 16 stored in the memory (step 142). Here, the window status information includes the process IDs of the applications that have opened the windows that the user is currently working on.

Rule interpreting unit 17 also obtains the activated AP information that the message processing unit 13 stored in the memory (step 143). Here, the activated AP information includes the application names and the process IDs.

Rule interpreting unit 17 replaces the process IDs included in the window status information obtained in step 142 with the application names by referring to the activated AP information obtained in step 143, to regenerate the window status information (step 144). Assuming that the IM status agent has acquired the process ID of the IM upon activation thereof, if that process ID is among the process IDs included in the window status information, the rule interpreting unit 17 replaces that process ID with the application name “IM”. Further, if the process ID included in the activated AP information obtained in step 143 is not among the process IDs included in the window status information, the rule interpreting unit 17 replaces that process ID with a blank, for example, to indicate that the windows the user is currently working on include a window that was activated from an application other than the IM.

Further, the rule interpreting unit 17 obtains the IM status information that the message processing unit 13 stored in the memory (step 145).

Rule interpreting unit 17 performs matching between the window status information and the window status definition, and between the IM status information and the IM status definition (step 146). It then determines whether the window status information and the IM status information match the window status definition and the IM status definition, respectively (step 147).

If they both match, the rule interpreting unit 17 transmits an IM status modification instruction to the message processing unit 13, in accordance with the IM status modification definition included in the rule definition read in step 141 (step 148). The IM status modification instruction may be, e.g., an instruction to change the IM status message to the one that is associated with the window status definition and the IM status definition. When the IM status message is transmitted to the message processing unit 13 according to the above operation, the message processing unit 13 passes the status message to the communication unit 11, which in turn transmits it to another client 10.

On the other hand, if either one does not match, the process is terminated, without transmitting the IM status modification instruction to the message processing unit 13.

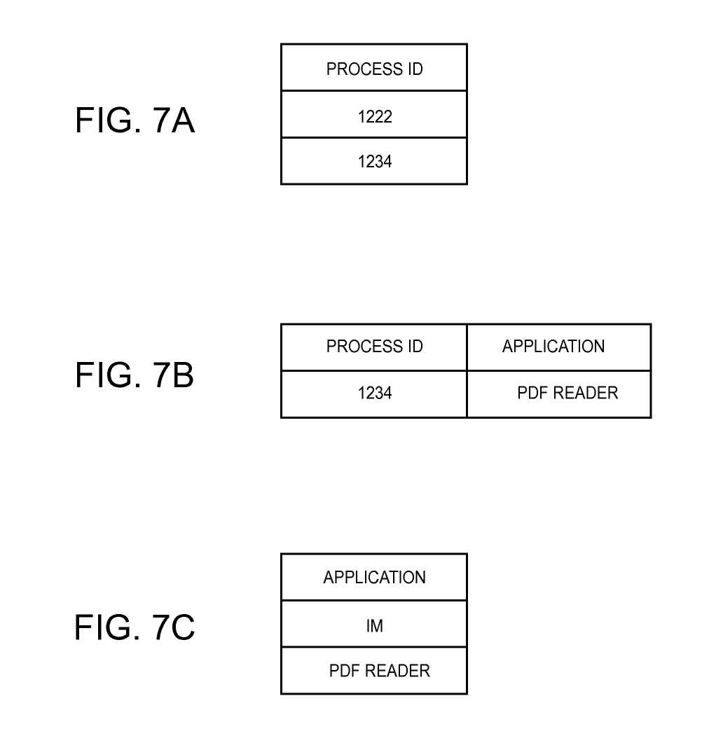

The information obtained in step 142, obtained in step 143, and generated in step 144 will be described with reference to specific examples, as shown by FIG. 7A. FIG. 7A shows a specific example of the information obtained in step 142.

It can be assumed, for the example, that focus is switched between two windows, and the process IDs of the applications that opened the respective windows are shown in the form of a table. Of the process IDs, “1222” is the process ID for the IM, and “1234” is the process ID for “PDF Reader”.

FIG. 7B shows a specific example of the information obtained in step 143.

It is assumed that “PDF Reader” has been activated, and the correspondence between the process ID “1234” and the application name “PDF Reader” is shown in the form of a table.

FIG. 7C shows a specific example of the information generated in step 144.

Because the IM status agent knows that the process ID “1222” in FIG. 7A is the process ID of the IM, it replaces “1222” in the first row in FIG. 7A with “IM”. Further, by referring to the correspondence between the process ID and the application name in FIG. 7B, it replaces the process ID “1234” in the second row in FIG. 7A with “PDF Reader”. As a result, the window status information is regenerated in the form of a table showing the application names of the applications that opened the windows between which focus is switched.

The status matching processing in step 146 in FIG. 6 is carried out on the assumption that the window status information as shown in FIG. 7C has been generated as described above.

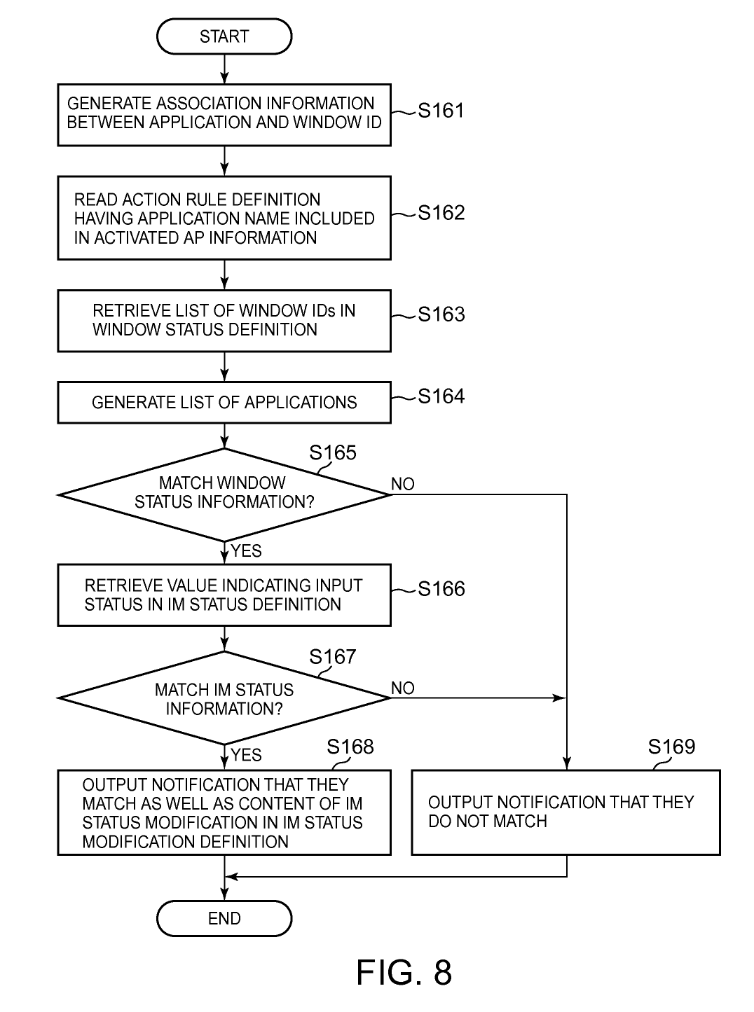

FIG. 8 is a flowchart illustrating an example of the operation in the matching processing.

Rule interpreting unit 17 generates association information between the application name and the window ID, according to the window definition which is included in the rule definition read in step 141 in FIG. 6 (step 161). For example, assuming that the action rule definition as shown in FIG. 3 has been read, the association information between the application name “PDF Reader” and the window ID “1” is generated. If there is another action rule definition, the association information between the application name and the window ID is generated by referring to the other action rule definition as well.

Rule interpreting unit 17 reads the action rule definition in which the application name included in the activated AP information obtained in step 143 in FIG. 6 is described (step 162).

Further, the rule interpreting unit 17 retrieves the list of window IDs included in the Focus attribute in the window status definition (step 163). It then specifies the application corresponding to a respective window ID in the list, to generate a list of applications (step 164). If the window ID is “0”, the application is “IM”. If the window ID is other than “0”, the application is specified based on the association information between the application name and the window ID generated in step 161. For example, the rule definition shown in FIG. 3 includes the list of window IDs of “0” and “1”. Here, the IM is specified as the application from the window ID “0”, and the application “PDF Reader” is specified from the window ID “1”, based on the association information generated in step 161.

Rule interpreting unit 17 determines whether the applications included in the list of applications generated in step 164 match the applications included in the window status information generated in step 144 (step 165).

If they match, the rule interpreting unit 17 obtains the value that is set in the Input attribute in the IM status definition (step 166). It then determines whether the status indicated by that value matches the status indicated by the IM status information obtained in step 145 (step 167).

If they match, the rule interpreting unit 17 outputs a notification that they match as well as the IM status modification instruction described in the IM status modification definition (step 168). In the present embodiment, particularly, the instruction to change the IM status message is output.

On the other hand, if the result of matching is “NO” in step 165 or 167, the rule interpreting unit 17 outputs a notification that they do not match to the message processing unit 13 (step 169).

While the negation symbol described in conjunction with the rule definition in FIG. 3 above has not been considered in this operation example, the operation may take account of the negation symbol.

For example, in the case where a negation symbol is added to the list of the window IDs, it may be determined in step 165 whether the condition that the window status information generated in step 144 (e.g., the information shown in FIG. 7C) does not include any of the applications included in the list generated in step 164 is satisfied. If the condition is satisfied, the process may proceed to step 166; otherwise, the process may proceed to step 169.

In the case where a negation symbol is added to one or more of the window IDs in the list, it may be determined in step 165 as follows: In the list of applications generated in step 164, for the application having the window ID not added with the negation symbol, it may be determined whether the condition that the application is included in the window status information generated in step 144 (e.g., the information shown in FIG. 7C) is satisfied, while for the application having the window ID added with the negation symbol, it may be determined whether the condition that the application is not included in the window status information generated in step 144 (e.g., the information shown in FIG. 7C) is satisfied. If every one of the applications on the list satisfies the corresponding one of the former and latter conditions, the process may proceeds to step 166; whereas if any one of the applications in the list fails to satisfy the corresponding condition, the process may proceed to step 169.

It is noted that the matching algorithm described above with reference to FIGS. 7 and 8 is only illustrative; any other matching algorithm may be adopted.

An embodiment of the disclosure has been described above in detail. In the present embodiment, in the case where the focus is switched between the window for the IM and the window for the “PDF Reader” and a message is being input to the IM, the status message “Now Making Comments on the Document” is output to indicate that the user is inputting a message to the IM while viewing the document using “PDF Reader”. However, various other situations are conceivable as to what kind of status message is to be output when what kind of condition is satisfied.

For example, it may be configured such that a condition of Focus=” 1″ and Input=“0” is defined in advance and, when the condition is satisfied, a status message indicating that the user is viewing the document using “PDF Reader” before inputting a message to the IM is output.

Further, another situation not taking account of the condition regarding the status of the message in the IM is conceivable.

For example, it may be configured such that a condition of Focus=” 1″ alone is defined in advance and, upon satisfaction of the condition, a status message indicating that the user is doing work using “PDF Reader” for the purpose of message exchange is output.

Alternatively, it may be configured to define a condition of Focus=!“1” (“!” is the negation symbol) alone and, in response to satisfaction of the condition, to output a status message indicating that the user is not doing work using “PDF Reader” for the message exchange.

Still another situation not taking account of the condition regarding the status of the window is conceivable as well.

In this case, the user status information showing the user status may be stored in association with “PDF Reader” in advance and, when “PDF Reader” is activated from the IM, the associated user status information may be output.

Further, it has been assumed in the present embodiment that the data transmitted by the IM is a PDF file and the PDF viewing software is activated from the IM for viewing the PDF file. However, this is only illustrative; the data transmitted by the IM may be of any format and may be viewed using any software.

Furthermore, while it has been assumed in the present embodiment that the user exchanges messages with only one party, in the case where the user chats with a plurality of parties individually, the above-described process may be performed on a respective chat session.

As described above, in the present embodiment, the condition regarding the window status and the condition regarding the message in the IM, and the status message indicating the user status are associated with each other for each of the applications that may be activated from the IM, and in the case where an actual status satisfies the conditions, the status message is output. This provides the other party of communication with the presence information, not of the type such as “on the phone”, “available”, “away”, and the like, but from the standpoint of whether the user is doing work related to the chat using the software activated from the IM.

Further, in most cases, obtaining the user activity information requires only modification of the IM software and use of the function of the window system, without the need of modification of the applications.

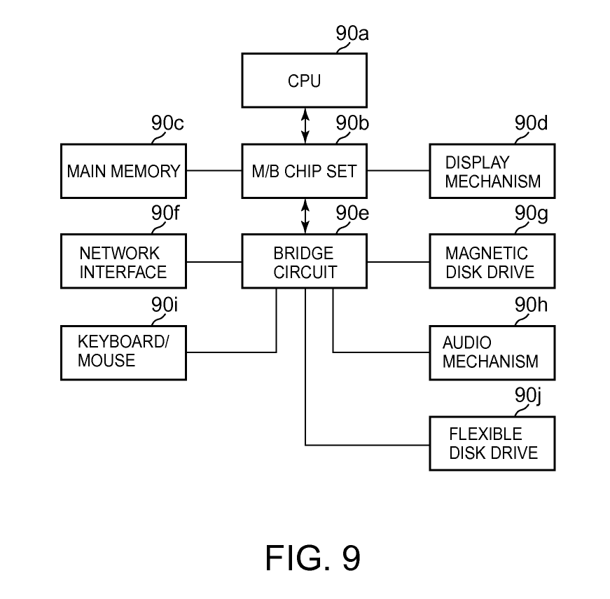

A hardware structure of a computer suitable for implementing the present embodiment will be described. FIG. 9 shows an example of the hardware structure of such a computer. As shown in the figure, the computer includes a CPU (Central Processing Unit) 90a serving as calculating means, a main memory 90c connected to the CPU 90a via an M/B (motherboard) chip set 90b, and a display mechanism 90d connected to the CPU 90a again via the M/B chip set 90b. Further, a network interface 90f, a magnetic disk drive (hard disk drive: HDD) 90g, an audio mechanism 90h, a keyboard/mouse 90i, and a flexible disk drive 90j are connected to the M/B chip set 90b via a bridge circuit 90e.

In FIG. 9, the components are connected via buses. For example, the CPU 90a and the M/B chip set 90b, and the M/B chip set 90b and the main memory 90c are connected via a CPU bus. While the M/B chip set 90b and the display mechanism 90d may be connected via an AGP (Accelerated Graphics Port), if the display mechanism 90d includes a PCI Express-capable video card, the M/B chip set 90b and the video card are connected via a PCI Express (PCIe) bus. Further, for connection with the bridge circuit 90e, PCI Express, for example, may be used for the network interface 90f. For the magnetic disk drive 90g, serial ATA (AT Attachment), parallel ATA, or PCI (Peripheral Components Interconnet) may be employed. Further, a USB (Universal Serial Bus) may be used for the keyboard/mouse 90i and the flexible disk drive 90j.

While the disclosure has been described with reference to the embodiment, the description of the embodiment above does not restrict the technical scope of the disclosure. Those skilled in the art will appreciate that various modifications and substitutions are possible, without departing from the scope and spirit of the invention.

What is claimed is:

1. A method comprising:
instantiating at least two applications on a client device, each of the at least two applications comprising a user interface for interacting with a user, wherein one of the applications is a real-time communication application through which a user is participating in a real-time communication session with at least one remotely located user and wherein another of the application is referred to as a second application;
determining status information relating to user interactions with the second application;
generating a status message comprising content from the determined status information, wherein the status message is generated without manually entered user input; and
automatically and without manual user input, conveying the status message to the at least one remotely located user via the real-time communication application during the real-time communication application.

2. The method of claim 1, further comprising:
determining whether the user interactions with the second application are related to a discussion of the communication session; and
if the user interactions with the second application are related to the discussion of the communication session, generating the status message, which is not generated and conveyed to the remotely located user if the user interactions with the second application are not related to the discussion.

3. The method of claim 1, wherein the real-time communication session is a session in which the user and the remotely located user exchange text messages with each other.

4. The method of claim 1, wherein the real-time communication session is a server-assisted session, where a server maintains presence information of the user and the remotely located user, wherein the server provides the presence information of the remotely located user to the user via the user interface of the real-time communication application.

5. The method of claim 1, wherein the real-time communication application is an instant messaging application.

6. The method of claim 1, wherein the real-time communication application is an instant messaging (IM) application, wherein the real-time communication session is an IM communication session, said method further comprising:
executing an IM status agent on the client device; and
determining at least one active window for the section application, wherein the status message indicates that the user is interacting via the second application.

7. The method of claim 1, further comprising:
storing association information in a storage medium of the client device, wherein the association information comprises user status information indicating the status of the user in regards to the second application, wherein the status information of the determining step includes the stored association information; and
executing at least one rule driven by the status information, wherein satisfaction of conditions of the rule causes the status message to be generated and conveyed, wherein non-satisfaction of conditions of the rule results in the status message not being generated and not being conveyed.

8. The method of claim 1, wherein the second application is launched from the user interface of the real-time communication application, wherein the status message indicates that the second application is being used by the user and that the second application has focus.

9. A computer program product comprising:
a computer-readable storage medium; and
computer-readable program code embodied in the computer-readable storage medium, wherein the computer-readable program code comprises a set of instructions able to be executed by a processor, wherein said computer-readable program code is configured to:
instantiate at least two applications on a client device, each of the at least two applications comprising a user interface for interacting with a user, wherein one of the applications is a real-time communication application through which a user is participating in a real-time communication session with at least one remotely located user and wherein another of the application is referred to as a second application;
determine status information relating to user interactions with the second application;
generate a status message comprising content from the determined status information, wherein the status message is generated without manually entered user input; and
automatically and without manual user input, convey the status message to the at least one remotely located user via the real-time communication application during the real-time communication application.

10. The computer program product of claim 9, wherein said computer-readable program code is configured to:
determine whether the user interactions with the second application are related to a discussion of the communication session; and
if the user interactions with the second application are related to the discussion of the communication session, generate the status message, which is not generated and conveyed to the remotely located user if the user interactions with the second application are not related to the discussion.

11. The computer program product of claim 9, wherein the real-time communication application is an instant messaging (IM) application, wherein the real-time communication session is an IM communication session, wherein said computer-readable program code is configured to:
execute an IM status agent on the client device; and
determine at least one active window for the section application, wherein the status message indicates that the user is interacting via the second application.

12. The computer program product of claim 9, wherein the second application is launched from the user interface of the real-time communication application, wherein the status message indicates that the second application is being used by the user and that the second application has focus.

13. A computing device comprising:
at least one processor;
at least one computer-readable storage medium;
a bus connecting said at least one processor to the at least one computer-readable storage medium,
said at least one computer-readable storage medium storing computer-readable program code comprising a set of instructions able to be executed by said at least one processor, wherein said computer-readable program code is configured to:
instantiate at least two applications on a client device, each of the at least two applications comprising a user interface for interacting with a user, wherein one of the applications is a real-time communication application through which a user is participating in a real-time communication session with at least one remotely located user and wherein another of the application is referred to as a second application;
determine status information relating to user interactions with the second application;
generate a status message comprising content from the determined status information, wherein the status message is generated without manually entered user input; and
automatically and without manual user input, convey the status message to the at least one remotely located user via the real-time communication application during the real-time communication application.

14. The computing device of claim 13, wherein said computer-readable program code is configured to:
determine whether the user interactions with the second application are related to a discussion of the communication session; and
if the user interactions with the second application are related to the discussion of the communication session, generate the status message, which is not generated and conveyed to the remotely located user if the user interactions with the second application are not related to the discussion.

15. The computing device of claim 13, wherein the real-time communication session is a session in which the user and the remotely located user exchange text messages with each other, and wherein the real-time communication session is a server-assisted session, where a server maintains presence information of the user and the remotely located user, wherein the server provides the presence information of the remotely located user to the user via the user interface of the real-time communication application.

16. The computing device of claim 13, wherein the real-time communication application is an instant messaging (IM) application, wherein the real-time communication session is an IM communication session, wherein said computer-readable program code is configured to:
execute an IM status agent on the client device; and
determine at least one active window for the section application, wherein the status message indicates that the user is interacting via the second application.

17. A method comprising:
executing an instant messaging (IM) status agent on a client device, which also executes an IM application having a user interface through which a human user corresponds to at least one remotely located user during an IM communication session;
determining at least one active window for an application that is not the IM application, wherein the application is referred to as a second application;
generating without manual user input from the human user a status message, wherein said status message indicates that the human user is interacting via the second application; and
conveying the status message via the IM application to the at least one remotely located user.

18. The method of claim 17, further comprising:
determining whether the second application is related to the IM communication session or not;
responsive to a determination that the second application is related to the IM communication session, performing the generating and conveying of the status message, wherein the performing of the generating and conveying of the status message is contingent upon the determination that the second application is related to the IM communication session; and
responsive to a determination that the second application is not related to the IM communication session, not performing the generating and conveying of the status message.

19. The method of claim 17, further comprising:
detecting that the second application is launched from the IM application during the IM communication session;
determining that the second application is related to the IM communication session due to it having been launched from the IM application; and
responsive to determining the second application performing the generating and conveying of the status message, wherein the performing of the generating and conveying of the status message is contingent upon the determination that the second application is related to the IM communication session.

20. The method of claim 17, further comprising:
during the IM communication session, using the IM status agent to determine a status of a plurality of different window elements, each window element having an associated application name, a window identifier for the corresponding object window;
determining the second application is activate using the window element corresponding to the second application; and
including the application name for the second application obtained from the window element within the generated status message.

21. The method of claim 20, wherein each window element further comprises a launcher Id, which is a window identifier of a window that caused the corresponding window element to be launched;
determining whether the launcher id of the window element of the second application is the window id of the IM application;
responsive to determining the launcher id is the window id of the IM application, performing the generating and conveying of the status message, wherein the performing of the generating and conveying of the status message is contingent upon the determination that the launcher id of the window element of the second application is the window id of the IM application.

22. The method of claim 17, further comprising:
determining a window state for windows corresponding to the IM application and the second application, wherein the window state indices whether corresponding windows have focus or not and are visible or not, wherein the performing of the generating and conveying of the status message is contingent upon and responsive to satisfaction of at least one previously designated rule, where whether the previously designated rule is satisfied or not is conditioned upon the window state of the IM application and the second application.

23. The method of claim 17, wherein the IM status agent is a plug-in of the IM application or is a code module integrated within the IM application.

24. The method of claim 17, wherein the IM application comprises a file transfer functionality, said method further comprising:
receiving a file of a type associated with the second application via the IM application; and
opening the file from the IM application, which launches the second application, wherein the status message indicates that a window associated with the second application is open and has focus or indicates that the human user of the client device is viewing the file.

25. The method of claim 17, wherein the conveying of the status message via the IM application occurs automatically and without manual user input for sending the status message being entered by the user within the IM application.
